(19) United States
(12) Patent Application Publication
(10) Pub. No.: US 2006/0238371 A1
(43) Pub. Date: Oct. 26, 2006

(54) Remote control system of electric equipment

(75) Inventors: Wen-Jiunn Tsay, Hsin-Chu (TW); Cheng-Yu Wang, Hsin-Chu (TW); Ming-Lin Tien, Hsin-Chu (TW)

Correspondence Address: KUSNER & JAFFE;HIGHLAND PLACE SUITE 310, 6151 WILSON MILLS ROAD, HIGHLAND HEIGHTS, OH, 44143, US

(73) Assignee: AboCom Systems, Inc.

(21) Appl. No.: 11/114,655

(22) Filed: Apr. 26, 2005

(51) Int. Cl. H04N 9/12

(52) U.S. Cl. 340/825.69

(57) ABSTRACT

Remote control system of an electric equipment comprises a control plane and an under-control plane. The control plane comprises a micro controller. A channel switch module has a plurality of channels, and the micro controller is electrically connected to the channel switch module to select one channel of the pluralities of channels or perform a channel switch of the pluralities of channels. A first blue tooth module is electrically connected to the micro controller. A first antenna is connected to first blue tooth module to emit a blue tooth wireless communication signal of the selected channel of the micro controller. The under-control plane comprises a plurality of antennas to receive the blue tooth wireless communication signal. A plurality of second blue tooth modules are connected to the pluralities of antennas respectively. A plurality of control modules are electrically connected to the pluralities of second blue tooth modules respectively. One of the pluralities of control modules corresponding to the selected channel of the micro controller may output a signal. A power source is connected to the pluralities of control modules.

### FIELD OF THE INVENTION

The present invention relates to a remote control system of an electric equipment, and more specially, to a remote control system of an electric equipment constructed by blue tooth module and communication protocol.

### DESCRIPTION OF RELATED ART

Conventionally, remote controller is classified as two types by transmission manner. Type one is so called IR remote controller which is controlled by employing IR transmission. Such transmission manner of the IR remote controller has an orientation property and its transmission distance is shorter. The IR remote controller is generally applied to an electric appliance, such as TV set, video recorder, air conditioner, refrigerator, or audio equipment . . . etc.. Type two is so called RF remote controller which is controlled by employing RF transmission. Such transmission manner of the RF remote controller has without orientation property and its transmission distance is longer. The RF remote controller is generally applied to garage, safety chain, wireless switch, car safety . . . etc..

Presently, mass production of remote controller is above-mentioned remote controller by transmission manner.

Moreover, remote controller is also classified as two types by code format. Type one is so called constant code remote controller which is employed the same data code emitted by the constant code remote controller. The constant code remote controller is often applied to a less safety concern situation or place owing to simple data code. Type two is so called hopping code remote controller which is which is employed the different data code in twice emitted by the hopping code remote controller. The hopping code remote controller is often applied to a strictly safety concern situation or place owing to complicate, difficult finding data code and high cost.

In view of the only employing aforesaid IR remote controller, it is an object of this invention to provide a new remote control system of electric equipment for meeting the requirement. Moreover, wireless communication range of remote controller by employing a blue tooth module and communication protocol is broader and without orientation limit than the IR remote controller, and emitting angle of the IR remote controller is limited.

### SUMMARY OF THE INVENTION

The object of the present invention is to disclose a remote control system of electric equipment provided with blue tooth module. The blue tooth is a communication specification of data delivering among various digital equipments. In general, the blue tooth is applied to mobile phone, notebook computer, personal digital assistant (PDA), etc.. The communicating distance of the blue tooth can reach over 10 meters, therefore it can be generally applied to remote controller.

The present invention discloses a remote control system of electric equipment. The remote control system of electric equipment comprises a control plane and an under-control plane. The control plane comprises a micro controller. A channel switch module has a plurality of channels, and the micro controller is electrically connected to the channel switch module to select one channel of the pluralities of channels or perform a channel switch of the pluralities of channels. A first blue tooth module is electrically connected to the micro controller. A first antenna is connected to first blue tooth module to emit a blue tooth wireless communication signal of the selected channel of the micro controller. The under-control plane comprises a plurality of antennas to receive the blue tooth wireless communication signal. A plurality of second blue tooth modules are connected to the pluralities of antennas respectively. A plurality of control modules are electrically connected to the pluralities of second blue tooth modules respectively. One of the pluralities of control modules corresponding to the selected channel of the micro controller may output a signal. A power source is connected to the pluralities of control modules.

The control plane further comprises a LCD interface connecting to the micro controller, and a battery connecting to the micro controller. The control plane further comprises an IEEE 802.11 module connecting to the micro controller, and a third antenna connecting to the IEEE 802.11 module. The control plane comprises a remote control panel (RCP). The control module comprises a relay and a controller. The controller comprises a Programmable Interrupt Controller (PIC). The relay is connected to the power source and an under-control device. The under-control device comprises a light bulb or an electric device. The electric device, for example, comprises computer, TV set, video recorder, air conditioner, refrigerator, or audio equipment (digital CD player, laser CD). The power source comprises an alternating current (AC) power source.

The channel switch module comprises a plurality of switches corresponding to a plurality of channels.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a first embodiment of a remote control system of electric equipment according to the present invention.

FIG. 2 illustrates a second embodiment of a remote control system of electric equipment according to the present invention.

### DETAILED DESCRIPTION OF THE PREFERRED EMBODIMENTS

The present invention discloses a remote control system of electric equipment constructed by blue tooth module and communication protocol.

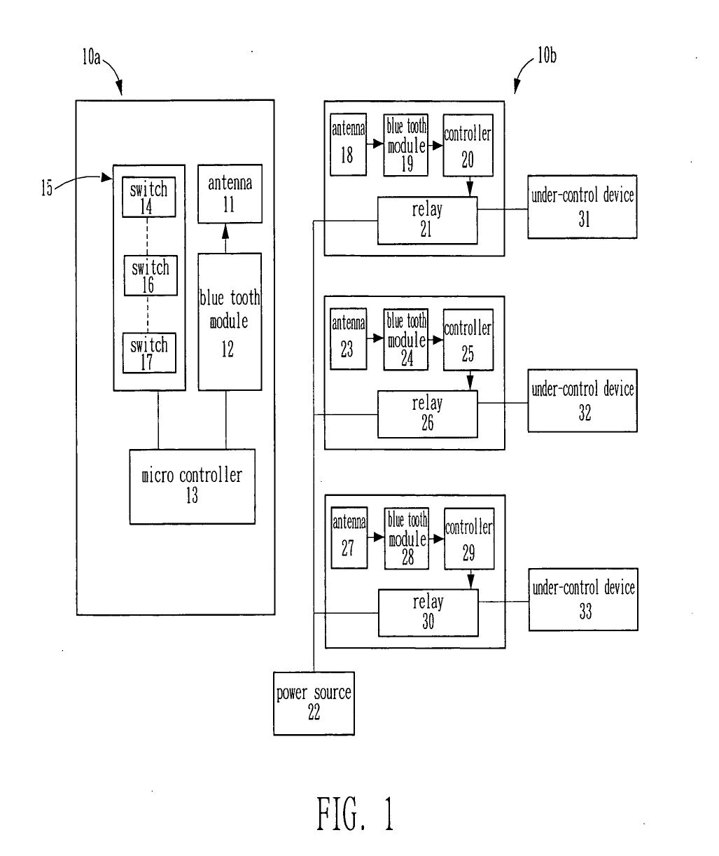

As shown in FIG. 1, it is a first embodiment of a remote control system of electric equipment according to the present invention. A remote control system of electric equipment of the present invention comprises a control plane 10a and an under-control plane 10b. The control plane 10a comprises a micro controller 13, channel switch module 15, blue tooth module 12 and antenna 11. The micro controller 13 is electrically connected to the channel switch module 15 and the blue tooth module 12. In general, above-mentioned module and controller are configured on a print circuit board to construct electrical connection. In still other instances, well-known structures, materials, or operations are not shown or described in detail to avoid obscuring aspects of various embodiments of the invention. The micro controller 13 may choose a channel through a switches 14,16,17 etc.. of the channel switch module 15, and then emit a blue tooth wireless communication signal of the selected channel via the antenna 11 through the blue tooth module 12. Moreover, channel switching may be accomplished through the switches 14,16,17 . . . transferring of the channel switch module 15 by employing the micro controller 13.

In general, the blue tooth module comprises an antenna, a filter (filtering a special frequency), a crystal transmitter, RF circuit, baseband signal processing circuit, flash memory, an accumulator, a capacitor and electromagnetic wave shield configured on a substrate. The crystal transmitter is an oscillator that is capable of creating about 2.4 GHz electromagnetic wave. The RF circuit, baseband signal processing circuit or flash memory are made of semiconductor devices.

Moreover, a blue tooth chip set may be integrated with a digital signal processor (DSP) as one single chip to reduce cost of the blue tooth module.

The control plane further comprises a battery connecting to the micro controller 13. In one embodiment, the control plane comprises a remote control panel (RCP).

The under-control plane 10b comprises a plurality of antennas, a plurality of blue tooth modules, a plurality of control modules and power source. The control module comprises a relay and a controller. The relay is electrically connected to the controller. In one embodiment, the controller is a Programmable Interrupt Controller (PIC).

The pluralities of antennas 18,23,27 receive a blue tooth wireless communication signal emitted by the antenna 11. Then, blue tooth modules 19,24,28 deliver the blue tooth wireless communication signal received by the antennas 18, 23, 27 to controllers 20, 25,2 9, respectively. Subsequently, a corresponding relay outputs the blue tooth wireless communication signal emitted by the antenna 11. For example, the blue tooth wireless communication signal controlled by the switches 14,16,17 is output by relays 21, 26, 30, respectively. The relays 21, 26, 30 are connected to a power source 22 and under-control devices 31, 32, 33, respectively. In one embodiment, the power source 22 is an alternating current (AC) power source. In one embodiment, the under-control devices 31, 32, 33 comprise but not limited an illuminating equipment, such as light bulb, or electric device. The electric device comprises but not limited a computer, TV set, video recorder, air conditioner, refrigerator, or audio equipment (digital CD player, laser CD).

In general, on/off status of the under-control devices 31,32,33 (such as electric appliances) may be controlled by the remote control system of the present invention.

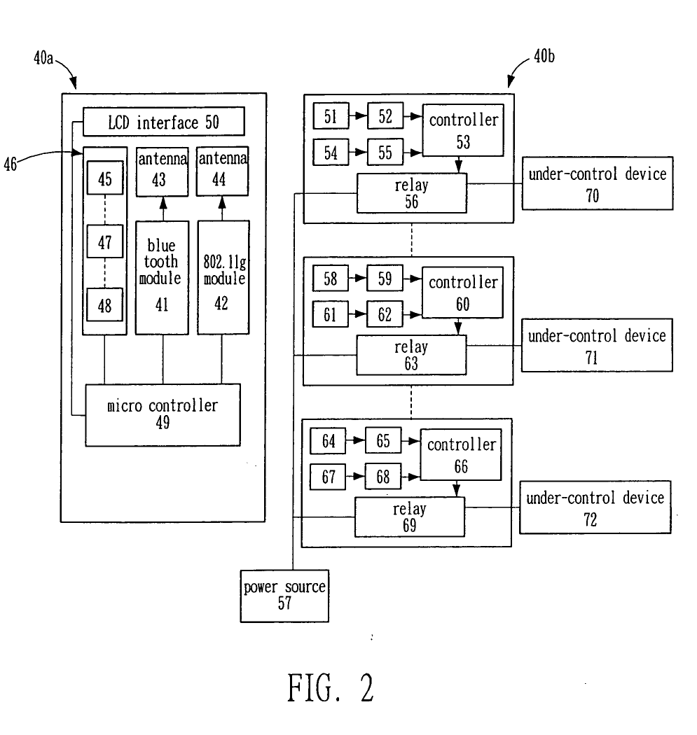

As shown in FIG. 2, it is a second embodiment of a remote control system of electric equipment according to the present invention. A remote control system of electric equipment of the present invention comprises a control plane 40a and an under-control plane 40b. The control plane 40a comprises a micro controller 49, channel switch module 46, blue tooth module 41, IEEE 802.11 module 42 and antennas 43, 44. The micro controller 49 is electrically connected to the channel switch module 46, IEEE 802.11 module 42 and the blue tooth module 41. The micro controller 49 may choose a channel through switches 45, 47, 48, etc. of the channel switch module 46, and then emit a wireless communication signal of the selected channel via the antenna 43 or 44 through the blue tooth module 41 or IEEE 802.11 module 42. Moreover, channel switching may be accomplished through the switches 45, 47, 48 . . . transferring of the channel switch module 46 by employing the micro controller 49.

In general, the blue tooth module comprises an antenna, a filter (filtering a special frequency), a crystal transmitter, RF circuit, baseband signal processing circuit, flash memory, an accumulator, a capacitor and electromagnetic wave shield configured on a substrate. The crystal transmitter is an oscillator that is capable of creating about 2.4 GHz electromagnetic wave. The RF circuit, baseband signal processing circuit or flash memory are made of semiconductor devices.

Moreover, a blue tooth chip set may be integrated with a digital signal processor (DSP) as one single chip to reduce cost of the blue tooth module.

Besides, IEEE 802.11 is also using a common band about 2.4 GHz electromagnetic wave to provide a 54 Mbps band.

The control plane further comprises a battery connecting to the micro controller 49. In one embodiment, the control plane comprises a remote control panel (RCP).

The control plane further comprises a LCD interface 50 connecting to the micro controller 49.

The under-control plane 40b comprises a plurality of antennas, a plurality of blue tooth modules, a plurality of IEEE 802.11 modules, a plurality of control modules and power source. The control module comprises a relay and a controller. The relay is electrically connected to the controller. In one embodiment, the controller is a Programmable Interrupt Controller (PIC).

The pluralities of antennas 51, 58, 64 receive a blue tooth wireless communication signal emitted by the antenna 43. The pluralities of antennas 54, 61, 67 receive a blue tooth wireless communication signal emitted by the antenna 44. Then, blue tooth modules 52, 59, 65 deliver the blue tooth wireless communication signal received by the antennas 51, 58, 64 to controllers 53, 60, 66, respectively. As the same, the IEEE 802.11 modules 55, 62, 68 deliver the wireless communication signal received by the antennas 54, 61, 67 to controllers 53, 60, 66, respectively. Subsequently, a corresponding relay outputs the blue tooth wireless communication signal emitted by the antenna 43. For example, the blue tooth wireless communication signal controlled by the switches 45, 47, 48 is output by relays 56, 63, 69, respectively. As the same, a corresponding relay outputs the blue tooth wireless communication signal emitted by the antenna 44. For example, the wireless communication signal controlled by the switches 45, 47, 48 is output by the relays 56, 63, 69, respectively. The relays 56, 63, 69 are connected to a power source 57 and under-control devices 70, 71, 72, respectively. In one embodiment, the power source 57 is an alternating current (AC) power source.

In one embodiment, the under-control devices 70,71,72 comprises but not limited an illuminating equipment, such as light bulb, or electric device. The electric device comprises but not limited a computer, TV set, video recorder, air conditioner, refrigerator, or audio equipment (digital CD player, laser CD). In general, on/off status of the under-control devices 70,71,72 (such as electric appliances) may be controlled by the remote control system of the present invention.

While the invention is described and illustrated here in the context of a limited number of embodiments, the invention may be embodied in many forms without departing from the spirit of the essential characteristics of the invention. The illustrated and described embodiments are therefore to be considered in all respects as illustrative and not restrictive. Thus, the scope of the invention is indicated by the appended claims rather than by the foregoing description, and all changes which come within the meaning and range of equivalency of the claims are intended to be embraced therein.

What is claimed is:

1. A remote control system of an electric equipment, comprising:
a control plane for emitting a blue tooth wireless communication signal, said control plane comprising;
a micro controller configured on a substrate;
a channel switch module configured on said substrate, said micro controller electrically connecting to said channel switch module to select channel or perform a channel switching;
a first blue tooth module electrically connected to said micro controller; and
a first antenna connected to said first blue tooth module to emit said blue tooth wireless communication signal of the selected channel of said micro controller; and
an under-control plane for receiving said blue tooth wireless communication signal, said under-control plane comprising;
a plurality of second antennas receiving said blue tooth wireless communication signal;
a plurality of second blue tooth modules connected to said plurality of antennas respectively;
a plurality of control modules electrically connected to said plurality of second blue tooth modules respectively, wherein at lease one of said plurality of control modules receives said blue tooth wireless communication signal corresponding to the selected channel of said micro controller; and
a power source connected to said plurality of control modules.

2. The system according to claim 1, further comprising a LCD interface connected to said micro controller.

3. The system according to claim 1, wherein said control plane comprises a remote control device.

4. The system according to claim 1, wherein said control module comprises a relay and a controller.

5. The system according to claim 4, wherein said controller comprises a Programmable Interrupt Controller (PIC).

6. The system according to claim 4, wherein said relay is connected to said power source.

7. The system according to claim 6, further comprising an under-control device connected to said relay.

8. The system according to claim 7, wherein said under-control device comprises an illuminating device.

9. The system according to claim 7, wherein said under-control device comprises electric device, said electric device comprising computer, TV set, video recorder, air conditioner, refrigerator, or audio equipment (digital CD player, laser CD).

10. The system according to claim 1, wherein said power source comprises an alternating current (AC) power source.

11. The system according to claim 1, wherein said channel switch module comprises a plurality of switches corresponding to a plurality of channels.

12. The system according to claim 1, wherein said control plane further comprises a battery connecting to said micro controller.

13. The system according to claim 1, wherein said control plane further comprises an IEEE 802.11 module connected to said micro controller.

14. The system according to claim 13, wherein said control plane further comprises a third antenna connected to said IEEE 802.11 module.

15. A control plane of a remote control system of electric equipment, comprising:
a micro controller configured on a substrate;
a channel switch module configured on said substrate, said micro controller electrically connecting to said channel switch module to select channel or perform a channel switching;
a blue tooth module electrically connected to said micro controller; and
an antenna connected to said blue tooth module to emit a blue tooth wireless communication signal of the selected channel of said micro controller.

16. The control plane according to claim 15, further comprising a LCD interface connected to said micro controller.

17. The control plane according to claim 15, wherein said control plane comprises a remote control device.

18. The control plane according to claim 15, wherein said channel switch module comprises a plurality of switches corresponding to a plurality of channels.

19. The control plane according to claim 15, wherein said control plane further comprises a battery connected to said micro controller.

20. The control plane according to claim 15, further comprises an IEEE 802.11 module connecting to said micro controller.

21. The control plane according to claim 20, wherein said control plane further comprises a third antenna connected to said IEEE 802.11 module.

22. An under-control plane of a remote control system of electric equipment, comprising:
a plurality of antennas receiving a blue tooth wireless communication signal;
a plurality of blue tooth modules connected to said plurality of antennas respectively;
a plurality of control modules electrically connecting to said plurality of blue tooth modules respectively, wherein at lease one of said plurality of control modules outputs a blue tooth wireless communication signal; and
a power source connecting to said plurality of control modules.

23. The under-control plane according to claim 22, wherein said control module comprises a relay and a controller.

24. The under-control plane according to claim 23, wherein said controller comprises a Programmable Interrupt Controller (PIC).

25. The under-control plane according to claim 23, wherein said relay is connected to said power source.

26. The under-control plane according to claim 25, further comprising an under-control device connected to said relay.

27. The under-control plane according to claim 26, wherein said under-control device comprises a light bulb.

28. The under-control plane according to claim 26, wherein said under-control device comprises electric device, said electric device comprising computer, TV set, video recorder, air conditioner, refrigerator, or audio equipment (digital CD player, laser CD).

29. The system according to claim 22, wherein said power source comprises an alternating current (AC) power source.
